(19) United States
(12) Patent Application Publication
(10) Pub. No.: US 2008/0298624 A1
(43) Pub. Date: Dec. 4, 2008

(54) MODULE AND APPARATUS FOR TRANSMITTING AND RECEIVING SOUND

(76) Inventors: Chi Hwan Jeong, Seoul (KR); Young Jon Yee, Seoul (KR)

Correspondence Address: BIRCH STEWART KOLASCH & BIRCH, PO BOX 747, FALLS CHURCH, VA, 22040-0747, US

(21) Appl. No.: 12/129,296

(22) Filed: May 29, 2008

(30) Foreign Application Priority Data
Jun. 1, 2007 (KR) 10-2007-0053868

(51) Int. Cl. H04R 25/00

(52) U.S. Cl. 381/380

(57) ABSTRACT

The module and apparatus for transmitting and receiving sound are disclosed in which a first channel is connected to an insertion of a microphone, a second channel is connected to a speaker insertion, such that sounds from the first and second channel are independently transmitted to prevent a first sound transmitted to the microphone and a second sound outputted from the speaker from being mixed, whereby noise generation can be obviated to improve characteristics of the module and the apparatus.

### CROSS-REFERENCE TO RELATED APPLICATION

The present application is based on, and claims priority from, Korean Application Numbers 10-2007-0053868, filed Jun. 1, 2007, the disclosure of which is incorporated by reference herein in its entirety.

### BACKGROUND

The following description relates generally to a module and an apparatus for transmitting and receiving sound by which sensitivity can be improved.

Typical headsets in the marketplace today are supported by a configuration in which speakers are disposed inside earplugs for both ears and a microphone is placed in front of a mouth of a user. In so doing, the headset allows both ears to be provided with voice signals, while the microphone allows obtaining the voice signals outputted from the mouth and providing the voice signals to an apparatus connected to the outside.

In most cases, there arises no big problem in transmitting to and receiving from the other party the voice signals using the aforementioned headset. However, it is very difficult to obtain only the voice signal of a user because the microphone is inputted with noises besides the voice signal outputted from the mouth of the user when the user is exposed to loud noises.

Furthermore, in cold weather, water vapor emitted from the mouth touches the microphone to make it cold and frosted, whereby the microphone is degraded in performance thereof to make it difficult for the user to normally receive the voice signal. If ambient temperature of the microphone falls below zero Celsius, the vapor from the mouth of the user gets iced on the microphone to reach a situation where the microphone ceases its function.

Many attempts have been waged to normally obtain voices of a user even under the aforementioned environments.

One of the methods for obtaining voices, not voice signals outputted from the mouth of a user is to obtain the voices of the user by detecting bone vibration generated by utterance of the user. This method is operated in such a manner that bone vibration generated by voices of a user is detected, and a bone vibration signal thus detected is transformed to a voice signal of the user to obtain the voices of the user when the user utters by employing a vibration sensor for detecting vibration of bones.

A more advanced method than that of detecting bone vibration is to detect voice pressure changes generated from the auditory canal in response to the user's utterance to obtain the voice of the user.

However, this advanced method suffers from a disadvantage in that it is not a method of directly obtaining the voice signal uttered from the mouth of the user but a method of indirectly obtaining the voice signal, such that the obtained voice signal has a characteristic different from that of the voice signal outputted from the mouth of the user to become a voice signal awkward to listening via ears. In case of simultaneously transmitting the voice signal from a speaker to ears and receiving the voice signal in ears generated by the utterance of the user via a microphone, the voice signal outputted from the speaker is mixed with the voice signal in the ears, such that a voice signal mixed with noises is received by the microphone.

### SUMMARY

An object of the present novel concept consists in providing a module and an apparatus for transmitting and receiving sound in which a first channel is connected to an insertion of a microphone, a second channel is connected to a speaker insertion, such that sounds from the first and second channel are independently transmitted to prevent a first sound transmitted to the microphone and a second sound outputted from the speaker from being mixed, whereby noise generation can be obviated to improve characteristics of the module and the apparatus.

Another object consists in providing a module and an apparatus for transmitting and receiving sound in which sound transmitted from a channel connected to a microphone can be compensated by the channel connected to the microphone to have the same characteristic as that of a voice signal generated by a mouth of a user, thereby improving sensitivity of the module and the apparatus.

In one general aspect, a module for transmitting and receiving sound comprises: a microphone detectable of a first sound generated by vibration of an eardrum; a speaker outputting a second sound; and a holder disposed with the microphone and the speaker in which the first sound and a second sound can be independently circulated.

In another general aspect, an apparatus for transmitting and receiving sound comprises: an earplug inserted into an ear canal in which the sound circulates; a module for transmitting and receiving the sound which includes a microphone detectable of a first sound generated by vibration by being connected to the earplug and a speaker outputting a second sound to the earplug; and a communication module receiving a signal relative to the second sound from an outside apparatus and outputting the signal to the module for transmitting and receiving sound, and receiving a signal relative to the first sound from the module for transmitting and transmitting the signal relative to the first sound to the outside apparatus.

### BRIEF DESCRIPTION OF THE DRAWINGS

FIG. 1 is an exemplary implementation of an apparatus for transmitting and receiving sound.

FIG. 2 is a schematic block diagram illustrating a headset.

FIG. 3 is a cross-sectional view of a module for transmitting and receiving sound.

FIG. 4 is a schematic exploded perspective view of a module for transmitting and receiving sound.

FIG. 5 is a partial cross-sectional view of a state in which an earplug is coupled to a holder.

FIG. 6 is a schematic partial cross-sectional view illustrating a state in which an anti-vibration unit is formed at a channel.

FIG. 7 is a schematic view illustrating a voice signal outputted from a mouth and a waveform of a sound signal generated from an ear canal.

FIG. 8 is a graph illustrating a frequency characteristic of sound signal generated from an ear canal.

FIG. 9 is a graph illustrating sensitivity in response to a frequency detected by an ear.

FIG. 10 is a schematic block diagram illustrating an acoustic echo canceller.

FIG. 11 is a graph illustrating compensation of a sound signal generated from an ear canal.

### DETAILED DESCRIPTION

While the present disclosure is susceptible to various modifications and alternative forms, certain implementations are shown by way of example in the drawings and, these implementations will be described in detail herein. It will be understood, however, that this disclosed concept is not intended to limit the disclosure to the particular forms described, but to the contrary, the disclosure is intended to cover all modifications, alternatives, and equivalents falling within the spirit and scope of the concept defined by the appended claims.

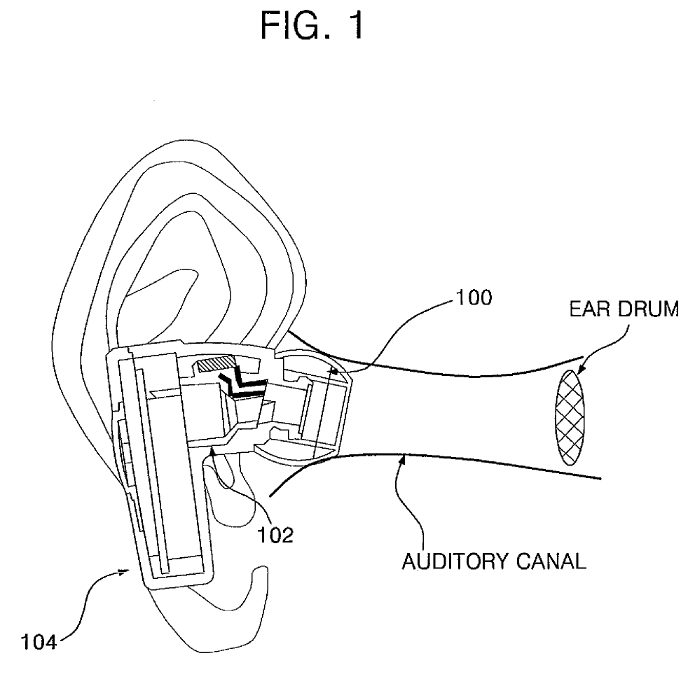

FIG. 1 is an exemplary implementation of an apparatus for transmitting and receiving sound, wherein the apparatus module for transmitting and receiving sound (herein after referred to as apparatus) may integrally comprise: an earplug (100) inserted into an ear canal; a module (102) for transmitting and receiving the sound connected to the earplug (100); and a communication module (104) capable of communication between an outside apparatus and the module (102) for transmitting and receiving sound.

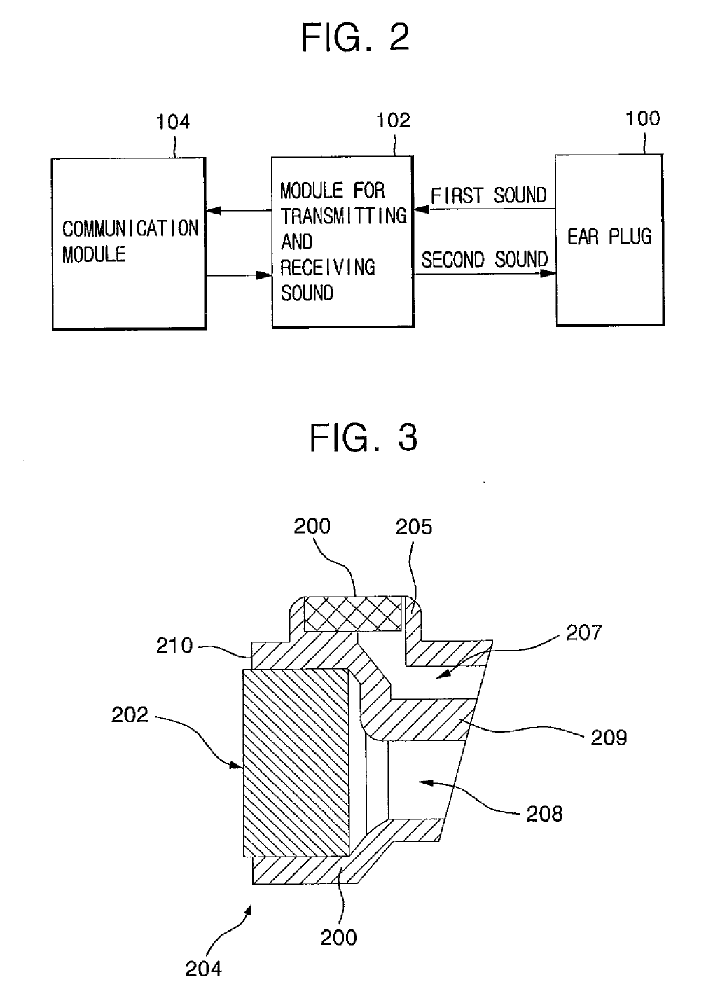

The apparatus of FIG. 1 may be a headset in the form of the earplug (100) being inserted into an ear canal. In other words, referring to FIG. 2, the apparatus may comprise: an earplug (100) inserted into an ear canal in which the sound circulates; a module (102) for transmitting and receiving the sound detectable of a first sound generated by vibration by being connected to the earplug (100) and outputting a second sound to the earplug (100); and a communication module (104) receiving a signal relative to the second sound from an outside apparatus and outputting the signal to the module (102) for transmitting and receiving sound, and receiving a signal relative to the first sound from the module (102) for transmitting and transmitting the signal relative to the first sound to the outside apparatus. Preferably, the communication module (104) is a wired or wireless communication module. Furthermore, the communication module is preferably a wireless communication module that communicates with a cellular phone. Still furthermore, the communication module may be a module capable of wirelessly communicating via a short distance wireless communication method. Besides, the wireless communication module may preferably include a battery unit if the communication module is a wireless communication module.

A user may insert the earplug (100) into an ear canal to listen to a sound transmitted from the outside using the apparatus for transmitting and receiving sound (referred to as the apparatus), and a sound generated by vibration of an eardrum by the utterance of the user may be transmitted to an outside apparatus.

Now, operation of the apparatus will be described. First of all, a first sound generated by the vibration of the eardrum may be detected by the module (102) for transmitting and receiving sound (hereinafter referred to as the module) via the earplug (100). A signal relative to the first sound detected by the module (102) may be transmitted to an outside apparatus by being inputted into the communication module (104). A signal relative to the second sound from the outside apparatus may be received by the communication module (104) and inputted into the module (102). Successively, the module (102) may output the second sound to the earplug (100), where the user may listen to the second sound via the earplug (100).

Now, driving of the apparatus will be explained. A first sound signal generated from the ear canal may be received by the module (102) via the earplug (100), and an output voice signal from the speaker may be transmitted to the ear canal. The communication module (104) may transmit the sound signal received by the microphone of the module (102) to a wirelessly connected outside apparatus, or may receive the sound signal transmitted from the outside apparatus and transmit the sound signal to the speaker of the module (102). As a result, it is possible to embody a small-sized microphone/speaker integrated apparatus for transmitting and receiving sound capable of being inserted into an ear canal using the module (102) proposed by the present inventive concept.

FIG. 3 is a cross-sectional view of a module for transmitting and receiving sound (the module), wherein the module may comprise: a microphone (200) detectable of a first sound generated by vibration of an eardrum; a speaker (202) outputting a second sound received by the communication module (104); and a holder (204) disposed with the microphone (200) and the speaker (202) in which the first sound and the second sound can be independently circulated.

The microphone (200) may include sound converters using electromagnetic, condenser, crystal and piezoelectric method. The holder (204) may include a microphone insertion (205) capable of fixedly inserting the microphone (200) and the speaker (202), and a speaker insertion (206). Furthermore, the holder (204) may include a first channel (207) capable of transmitting the first sound generated from the ear canal to the microphone (200), and a second channel (208) capable of transmitting the second sound outputted from the speaker (202) to the ear canal.

Referring again to FIG. 3, the microphone insertion (205) is preferably disposed on an upper surface of the holder (204), and the speaker insertion (206) is preferably disposed at a surface (210) opposite to a surface (209) on which the earplug is attached.

The second channel (207) of the holder (204) may be an acoustic waveguide connecting the speaker insertion (206) to the earplug, and the second channel (207) preferably has a shape of a curve-less acoustic waveguide in parallel with a second sound output direction of the speaker (202) so as to transmit the second sound outputted from the speaker (202) to the eardrum without maximally changing the second sound.

Furthermore, the first channel (207) of the holder (204) may be an acoustic waveguide connecting the microphone insertion (205) to the earplug and transmit the first sound generated by vibration of eardrum in the ear canal to the microphone (200) inserted into the microphone insertion (205).

Preferably, the first channel (207) performs signal compensation in such a manner that the first sound generated from the ear canal and transmitted to the microphone (202) has the same characteristic as that of the voice signal generated from a mouth of a user in order to improve the sensitivity of the module and the apparatus.

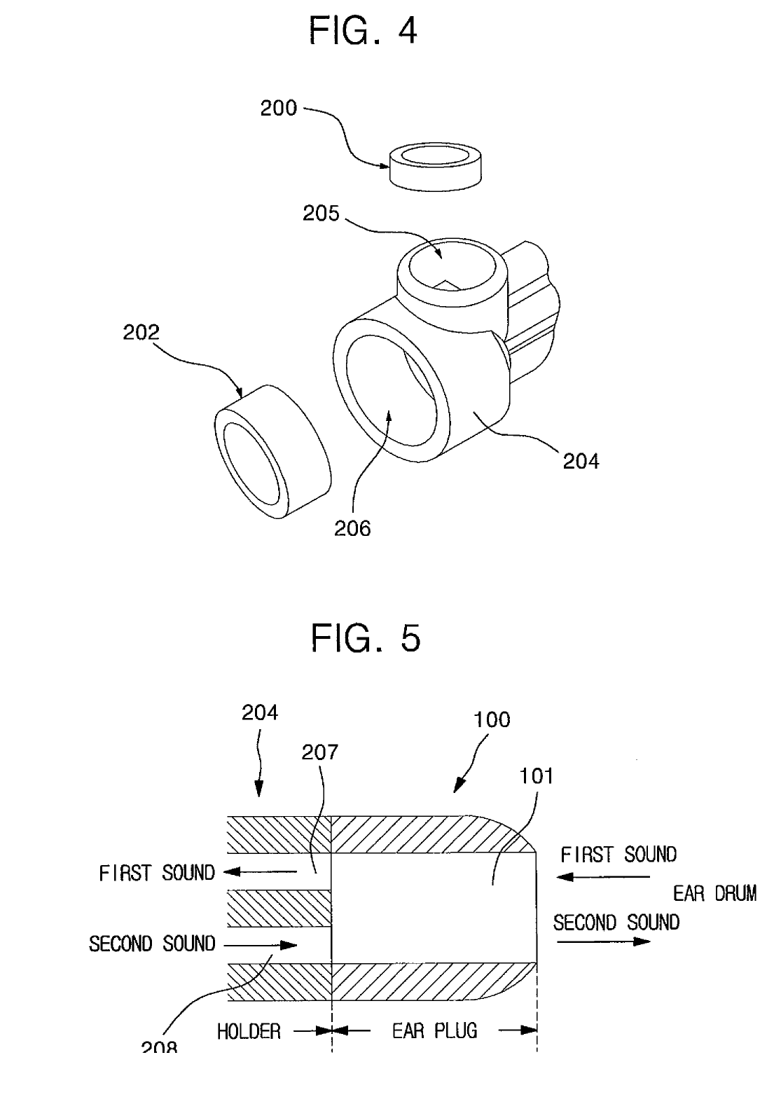

FIG. 4 is a schematic exploded perspective view of a module for transmitting and receiving sound.

Referring to FIG. 4, the holder (204) may be disposed with the microphone insertion (205) and the speaker insertion (206), where the microphone insertion (205) may be inserted by the microphone (200), and the speaker insertion (206) may be inserted by the speaker (202). The microphone insertion (205) and the speaker insertion (206) may be respectively connected to the first and second channel.

In other words, because the microphone insertion (205) is connected to the first channel, the speaker insertion (206) is connected to the second channel, and the first and second channels are isolated, the first sound transmitted to the microphone (200) may not be mixed with the second sound outputted from the speaker (202) to enable a prevention of generation of noises.

The module thus configured may be applied to earphones, headphones, headsets and hands-free apparatuses, and wired/wireless hand-held communication devices.

FIG. 5 is a partial cross-sectional view of a state in which an earplug is coupled to a holder, where the holder (204) and the earplug (100) may be coupled. However, it is preferable that the holder (204) and the earplug (100) be attached.

The earplug (100) may be formed with a channel (101) in which sounds may be circulated and communicate with the first and second channels (207, 208) of the holder (204).

The first sound generated by the eardrum may be inputted into the first channel (207) of the holder (204) via the channel (101) of the earplug (100), and the second sound transmitted to the second channel (208) of the holder (204) may be transmitted to the eardrum via the channel (101) of the earplug (100). The channel of the earplug (100) is preferably composed of a pair of channels respectively communicating with the first and second channels (207, 208).

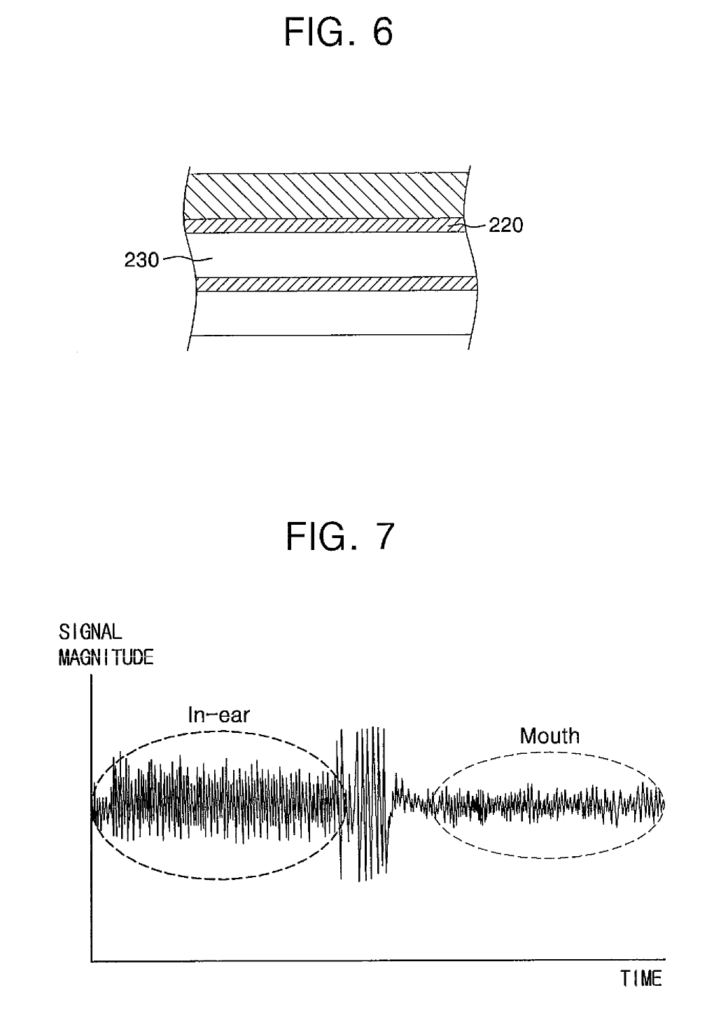

The holder may further include an anti-vibration unit capable of attenuating the mechanical vibration when the speaker is operated. In other words, the holder may be formed with an anti-vibration unit. The anti-vibration unit may be formed at any place of the holder. For example, the anti-vibration unit may be formed inside a channel (230) of the holder as illustrated in FIG. 6.

Preferably, the anti-vibration unit includes a portion formed with anti-vibration material for absorbing the vibration, and if the portion formed with the anti-vibration material is formed at the holder, the mechanical vibration may be attenuated when the speaker is operated. For example, the anti-vibration material may include a soft material such as silicon rubber or the like. If the holder has the anti-vibration capability, the mechanical vibration may be minimized in mixing into operation of the microphone to enable an improvement of sensitivity of the microphone.

Now, the characteristics of the first channel (207) of the holder (204) in the module will be described.

The voice signal outputted from a mouth of a man may not typically have the same signal characteristic as that of the sound signal generated from the ear canal by the utterance of the man. In other words, a path of utterance of a man generated from a mouth may be different from that of utterance generated from the movement of eardrum in an ear canal, such that a voice signal and a sound signal generated by the utterance of the same person are supposed to have the different characteristics.

As a result, in the module of the present inventive concept, the first sound generated from the ear canal is received by the microphone (202), and when the first sound received by the microphone (202) is again heard by the ears of a man, people cannot hear the first sound received by the microphone (202) in the spontaneous voice just like the voice signal outputted from the mouth of the man.

FIG. 7 is a schematic view illustrating a voice signal outputted from a mouth and a waveform of a sound signal generated from an ear canal.

Referring to FIG. 7, it can be noticed that the magnitude of a sound signal received in the ear canal is measured higher than that of a voice signal (a signal indicated as ‘mouth’ in FIG. 7) generated from a mouth of a man. However, if the voice signal uttered from a mouth of a man and a sound signal received by the eardrum are heard in an actual situation, the voice signal outputted from the mouth is more clearly heard.

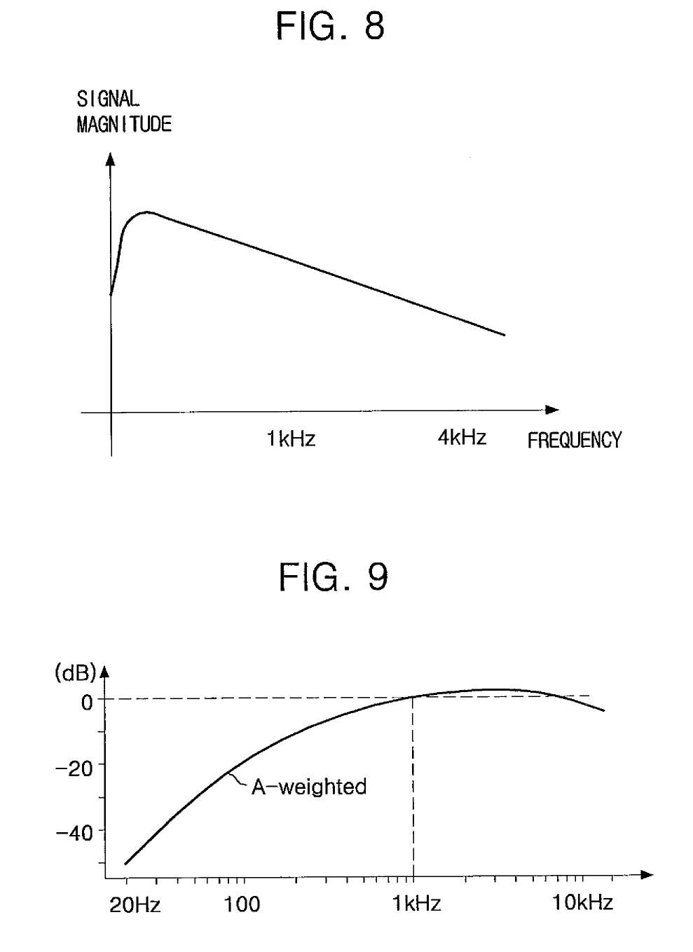

FIG. 8 is a graph illustrating a frequency characteristic of sound signal generated from an ear canal, where characteristic of the sound signal generated from the ear canal is illustrated based on signal magnitudes for each frequency band of the voice signal uttered from the mouth. In other words, the voice signal from the mouth is presumed to have a constant signal magnitude in all the frequency bands, from which the characteristic of the sound signal generated from the ear canal is illustrated. Therefore, the sound signal generated from ear canal by the utterance may be amplified in low frequency bands over the voice signal from the mouth, and the high frequency bands of the sound signal may have an attenuating frequency characteristic.

FIG. 9 is a graph illustrating sensitivity in response to a frequency detected by ears, where sensitivity of ears becomes abruptly dull into low frequency bands less than 1 KHz.

In other words, ears of a man has a low sensitivity relative to the voice signal of low frequency bands, but the sensitivity grows higher gradually to reach a maximum level in the vicinity of 1 KHz as the frequency of the voice signal increases. The signal characteristic of voice signals detected by ears is called A-weighted filter characteristic.

Meanwhile, in an spectrum analysis made for the sound signal generated from the ear canal and the voice signal uttered from a mouth, the sound signal from ear canal has higher frequency components in less than 1 KHz when compared with the voice signal from the mouth, but the frequency components greater than 1 KHz have a low signal characteristic. As a result, the sound signal generated from the ear canal is heard in low levels of sensitivity by ears of a man in terms of magnitude of frequency components of less than 1 KHz, such that the voice signal from the mouth is more clearly heard than the sound signal generated from the ear canal.

Based on the above theory, an acoustic impedance of the first channel of the holder (204) transmitting the sound signal generated from the ear canal to the microphone (202) is preferably adjusted to have a signal compensation configuration in which the sound signal inputted to the first channel has the same signal characteristic as that of the voice signal from the mouth.

The acoustic impedance of the first channel is determined by the shape, i.e., length and thickness of the channel. As noted in the above, the sound signal generated from ear canal as against the voice signal outputted from the mouth has higher frequency components in less than 1 KHz range, but has a signal characteristic of lower frequency components greater than 1 KHz range.

Therefore, it is preferable that the first channel of the holder (204) have a shape capable of performing an acoustic filtering function in which the sound signal generated from the ear canal in the magnitude of frequency components of less than 1 KHz range is attenuated, while the sound signal in the magnitude of frequency components greater than 1 KHz range is amplified. For example, the first channel proposed in the instant inventive concept preferably has a shape of performing the A-weighted filter attempt that simulates the sensitivity characteristic of an ear of a man.

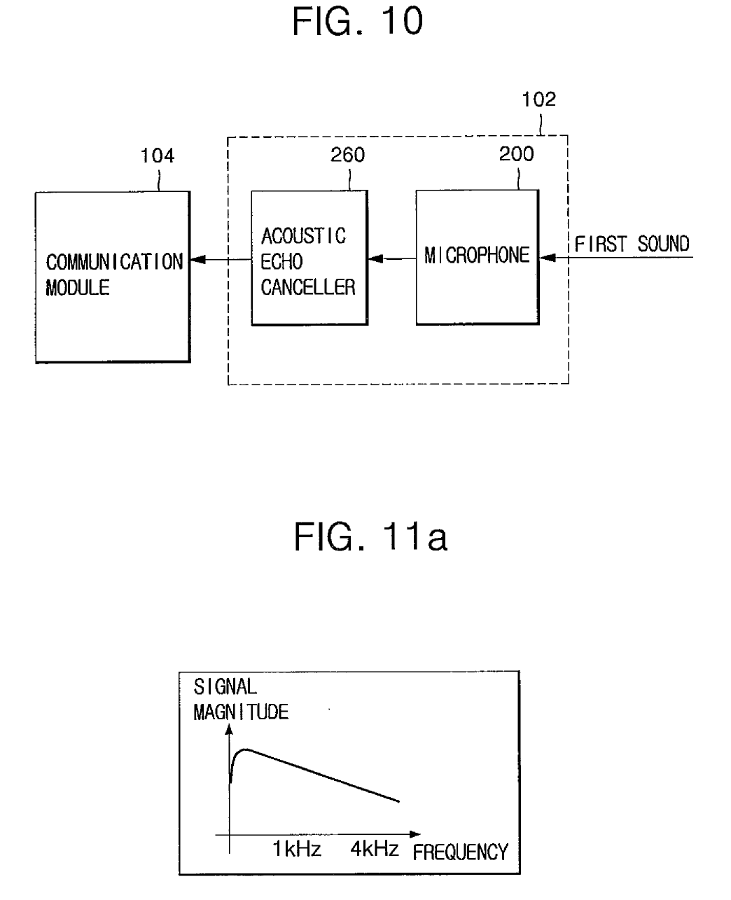

FIG. 10 is a schematic block diagram illustrating an acoustic echo canceller.

Referring to FIG. 10, the module is preferred to further include an acoustic echo canceller for removing the echo or howling phenomenon that is generated by the second sound being mixed into the microphone.

In other words, because there is a possibility that the first sound outputted from the microphone (200) includes the second sound component, the module (102) may further include an acoustic echo canceller (260) for canceling the echo or bowling phenomenon from the first sound outputted from the microphone (200), where the first sound outputted from the acoustic echo canceller (260) is inputted into the communication module (104).

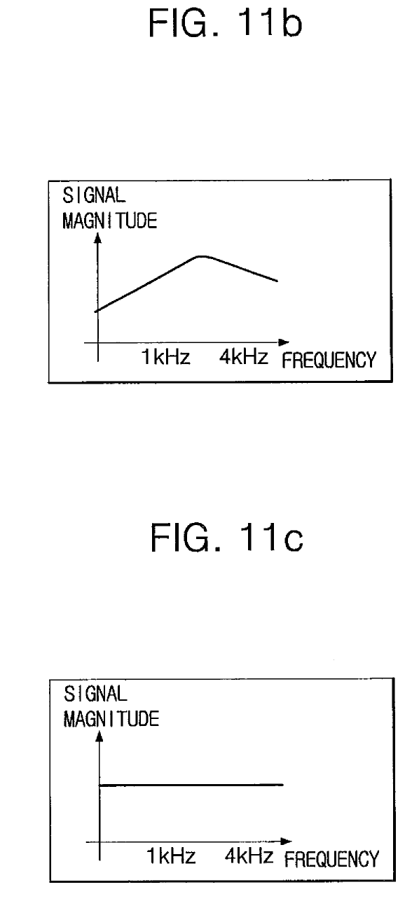

FIGS. 11a, 11b and 11c are a graph illustrating compensation of a sound signal generated from an ear canal, where a first sound is generated that has a frequency characteristic of FIG. 11a in response to vibration of the eardrum caused by the utterance of the user.

If the first channel of the holder (204) in the module is so designed as to perform a filtering function having the A-weighted characteristic, that is, if the first channel is so designed as to have a frequency characteristic of FIG. 11b, the first sound inputted into the microphone via the first channel is compensated in distortion thereof to have a frequency characteristic of FIG. 11c and to have the same characteristic as that of the voice signal generated from a mouth.

Therefore, the first channel may compensate in such a fashion that the first sound generated from the ear canal and transmitted to the microphone has the same characteristic as that of the voice signal generated from the mouth.

As apparent from the foregoing, there is an advantage in the module and apparatus for transmitting and receiving sound thus described in that the first channel is connected to the microphone insertion and the second channel is connected to the speaker insertion, and the first and second channels are so configured as to independently transmit the sound, thereby preventing noises from occurring.

Another advantage is that compensation is made in the channel connected to the microphone in such a manner that the sound transmitted to the microphone has the same characteristic as that of the voice signal generated from the mouth of a man, thereby improving the sensitivity of the module and apparatus for transmitting and receiving the sound.

Many alterations and modifications may be made by those having ordinary skill in the art, given the benefit of the present disclosure, without departing from the spirit and scope of the inventive subject matter. Therefore, it must be understood that the illustrated implementations have been set forth only for the purposes of example, and that it should not be taken as limiting the inventive subject matter as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive subject matter.

What is claimed is:

1. A module for transmitting and receiving sound comprising: a microphone detectable of a first sound generated by vibration of an eardrum; a speaker outputting a second sound; and a holder disposed with the microphone and the speaker in which the first sound and a second sound can be independently circulated.

2. The module as claimed in claim 1, wherein the holder includes a microphone insertion and a speaker insertion respectively capable of fixedly inserting the microphone and the speaker, and further includes a first channel capable of transmitting the first sound to the microphone and a second channel capable of transmitting the second sound to an ear canal.

3. The module as claimed in claim 1, wherein the first channel is an acoustic waveguide having an acoustic filter characteristic for attenuating the magnitude of frequency components of less than 1 KHz range of the first sound and for amplifying the magnitude of frequency components greater than 1 KHz range.

4. The module as claimed in claim 1, wherein the holder further includes an anti-vibration unit for attenuating the mechanical vibration when the speaker is operated.

5. The module as claimed in claim 1, wherein the holder includes a portion formed with an anti-vibration material for absorbing the vibration.

6. The module as claimed in claim 1, wherein the second channel is a curve-less acoustic waveguide.

7. An apparatus for transmitting and receiving sound comprising: an earplug inserted into an ear canal in which the sound circulates; a module for transmitting and receiving the sound which includes a microphone detectable of a first sound generated by vibration by being connected to the earplug and a speaker outputting a second sound to the earplug; and a communication module receiving a signal relative to the second sound from an outside apparatus and outputting the signal to the module for transmitting and receiving sound, and receiving a signal relative to the first sound from the module for transmitting and transmitting the signal relative to the first sound to the outside apparatus.

8. The apparatus as claimed in claim 7, wherein the module for transmitting and receiving the sound comprises: a microphone detectable of a first sound generated by vibration of an eardrum; a speaker outputting a second sound; and a holder disposed with the microphone and the speaker in which the first sound and a second sound can be independently circulated.

9. The apparatus as claimed in claim 8, wherein the module for transmitting and receiving the sound further comprises an acoustic echo canceller for removing the echo or howling phenomenon from the first sound outputted from the microphone.

10. The apparatus as claimed in claim 7, wherein the communication module is a communication module capable of wireless communication.

11. The apparatus as claimed in claim 8, wherein the first channel is an acoustic waveguide having A-weighted filter characteristic.

12. The apparatus as claimed in claim 8, wherein the holder further includes an anti-vibration unit for attenuating the mechanical vibration when the speaker is operated.

13. The apparatus as claimed in claim 7, wherein the communication module is a wireless communication module capable of communicating with a mobile phone.

14. The apparatus as claimed in claim 7, wherein the communication module is a module capable of wirelessly communicating in a local area wireless communication method.

15. The apparatus as claimed in claim 7, wherein the communication module is a wired communication module.

16. The apparatus as claimed in claim 10, wherein the communication module further includes a battery unit.
